(19) United States
(12) Patent Application Publication
(10) Pub. No.: US 2020/0160718 A1
(43) Pub. Date: May 21, 2020

(54) RIDE SHARING DEMAND AND PRICING VIA AUTOMOTIVE EDGE COMPUTING

(71) Applicant: Toyota Motor North America, Inc., Plano, TX (US)

(72) Inventor: Aghyad Saleh, Grand Prairie, TX (US)

(73) Assignee: Toyota Motor North America, Inc., Plano, TX (US)

(21) Appl. No.: 16/197,966

(22) Filed: Nov. 21, 2018

(51) Int. Cl. G08G 1/00; G06Q 50/30; G05D 1/00

(52) U.S. Cl. CPC G08G 1/202; G06Q 50/30; G01W 1/00; G05D 2201/0213; G05D 1/0088

(57) ABSTRACT

A system includes a processor and a non-transitory computer readable memory configured to store a machine-readable instruction set. The machine-readable instruction set causes the system to perform at least the following when executed by the processor: receive, from a sensor resource of a vehicle, information about an environment at a geographic location of the vehicle, associate a schedule of events with the geographic location, predict a demand in ride sharing requests based on the information about the environment and the schedule of events associated with the geographic location, and route one or more additional vehicles to or from the geographic location based on the predicted demand in ride sharing requests.

### TECHNICAL FIELD

The present specification generally relates to ride sharing systems and methods and, more specifically, systems and methods for predicting ride sharing demand and configuring pricing and resources in response to the predicted demand utilizing automotive edge computing.

### BACKGROUND

Ride sharing services arrange one-time ride shares on demand. Ride sharing services are made possible through widely implemented technologies. For example, GPS navigation, smartphone communication and social networks locate, connect, and establish a level of trust and accountability between drivers and passengers. A continuous challenge for ride sharing services and a source of passenger frustration is delivering on the expectation of an on-demand service. Many ride sharing services implement pricing adjustments as the actual demand for rides increases or decreases. However, as the number of competitors in the ride sharing space increases, maintaining a model of increasing prices with an increase in demand may cause passengers to switch to a competitor to find a better rate and a timelier available ride. As a result, a ride sharing service that is not able to meet the demand or adequately predict a future demand may lose rides.

### SUMMARY

In one embodiment, a system includes a processor and a non-transitory computer readable memory configured to store a machine-readable instruction set. The machine-readable instruction set causes the system to perform at least the following when executed by the processor: receive, from a sensor resource of a vehicle, information about an environment at a geographic location of the vehicle, associate a schedule of events with the geographic location, predict a demand in ride sharing requests based on the information about the environment and the schedule of events associated with the geographic location, and route one or more additional vehicles to or from the geographic location based on the predicted demand in ride sharing requests.

In some embodiments, a method includes receiving, from a sensor resource of a vehicle, information about an environment at a geographic location of the vehicle and associating a schedule of events with the geographic location. The method further includes predicting a demand in ride sharing requests based on the information about the environment and the schedule of events associated with the geographic location and routing one or more additional vehicles to or from the geographic location based on the predicted demand in ride sharing requests.

In some embodiments, a system includes a first vehicle having a first sensor resource and a first computing device, a second computing device comprising a processor and a non-transitory computer readable memory, a network communicatively coupling the first computing device and the second computing device, and a machine-readable instruction set stored in the non-transitory computer readable memory of the second computing device. The machine-readable instruction set causes the system to perform at least the following when executed by the processor: receive, from a sensor resource of a vehicle, information about an environment at a geographic location of the vehicle, associate a schedule of events with the geographic location, predict a demand in ride sharing requests based on the information about the environment and the schedule of events associated with the geographic location, and route one or more additional vehicles to or from the geographic location based on the predicted demand in ride sharing requests.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an illustrative map of a city indicating ride sharing vehicles according to one or more embodiments shown and described herein;

FIG. 2 schematically depicts components of a vehicle including sensor resources and a computing device according to one or more embodiments shown and described herein;

FIG. 3 depicts an illustrative embodiment of an automotive edge computing and communication system according to one or more embodiments shown and described herein;

FIG. 4 depicts an illustrative schedule of events associated with particular geographic locations according to one or more embodiments shown and described herein; and

FIG. 5 depicts a flowchart of an example method for predicting ride sharing demand and configuring pricing and resources in response to the predicted demand according to one or more embodiments shown and described herein.

### DETAILED DESCRIPTION

The embodiments disclosed herein relate to systems and methods for predicting ride sharing demand and configuring pricing and/or managing the number of ride sharing vehicles in response to the predicted demand utilizing automotive edge computing. As will be described in more detail herein, the systems and methods utilize information about an environment collected by vehicles within a geographic location and a schedule of events to predict increases and decreases in demand throughout an area, such as a city. Information about an environment collected by vehicles within a geographic location may include real-time or near-real-time information relating to weather conditions, vehicle traffic, population densities, the presence of accidents and/or construction, and the like. Any vehicle equipped with sensor resources and communication capabilities may collect information about an environment. For example, the vehicle collecting information may be a ride sharing vehicle or may be a non-ride share vehicle such as a personal vehicle, a truck, a bus or the like within the geographic location. It is understood that from time to time personal vehicles may be used as a tide share vehicle but may also be used as a non-ride share vehicle, for example, when the operator is using the vehicle for personal use and not seeking fide share requests. The information collected about a geographic location may be transmitted to a computing device. The computing device may be within a vehicle or may be a computing device communicatively coupled to one or more vehicles within the geographic location.

As described in more detail herein, the system may be a localized system for predicting ride sharing demand and configuring pricing and/or managing the number of ride sharing vehicles in response to the predicted demand utilizing automotive edge computing within a localized area. In some embodiments, the system may be configured to manage a large area, for example, one or more cities. However, generally fide sharing demand is localized to one or more local areas and not generally influenced by neighboring cities, for example, areas that are more than 20 or 30 miles in any direction. More particularly, since ride sharing is intended to provide local rides on request, the demand for ride sharing may be influenced by demand that is more locally defined, for example, within several city blocks of each other. Systems and methods for predicting ride sharing demand and configuring pricing and/or managing the number of ride sharing vehicles in response to the predicted demand utilizing automotive edge computing will now be described in more detail herein.

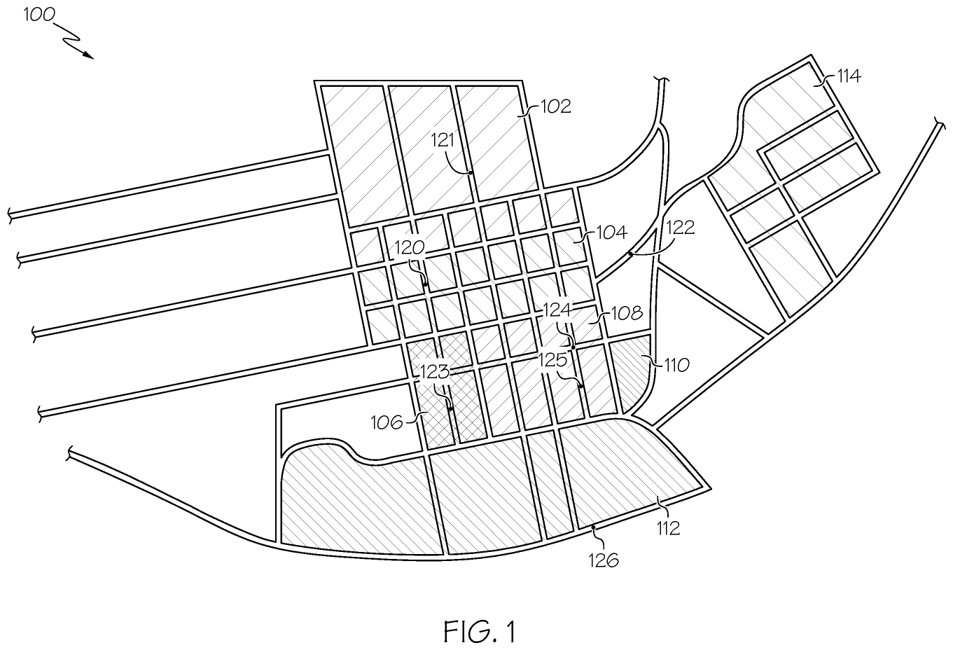

Turning now to the drawings wherein like numbers refer to like structures, is shown particularly to FIG. 1, an illustrative map 100 of a city indicating ride sharing vehicles. As shown, the example of the city may include a number of ride sharing vehicles (e.g., 120, 121, 122, 123, 124, 125, and 126) located about the streets of the city. Additionally, the example map illustrates predefined geographic locations within the city. Geographic locations may be defined by a particular address, a predefined number of blocks, or the city in general. In the map illustrated in FIG. 1, seven geographic locations, herein referred to as districts are defined. Each district may define a geographic location within the city that encompasses an area having a common theme, for example, a nightlife area having bars, lounges, clubs or the like.

For example, a first district 102 may define a geographic location within the city known for its nightlife scene and the area may generally include establishments catering to people interested in socializing with one another. A second district 104 may define a geographic location that generally includes a number of restaurants. A third district 106 may define a geographic location that generally includes a number of stores for shopping for goods. A fourth district 108 may define a geographic location that generally includes office buildings. A fifth district 110 may define a geographic location that generally includes a theater, symphony hall, art gallery or the like. A sixth district 112 may define a geographic location that generally includes entertainment, such as a concert venue, football arena, baseball stadium, or the like. A seventh district 114 may define a geographic location that generally includes residences.

It should be understood that these geographic locations are only illustrative and that an area may be defined by more or less geographic locations (e.g., districts). As will be discussed in more detail herein, the geographic locations may be associated with a schedule of events that may assist in predicting ride sharing demand with a geographic location.

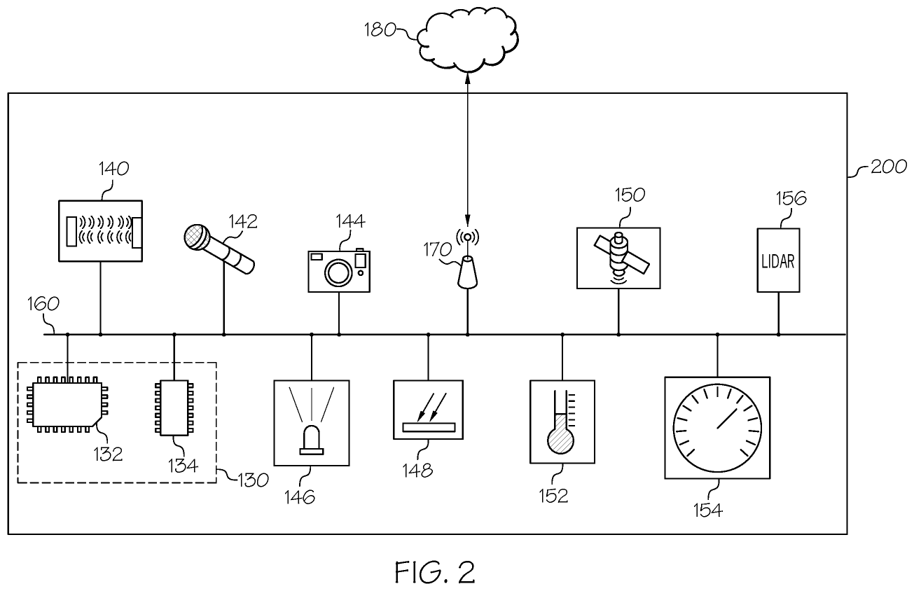

Referring now to FIG. 2., an example schematic of a vehicle 200 including sensor resources and a computing device is depicted. The vehicle 200 may be a ride sharing vehicle or another vehicle located within a geographic location that is configured to provide the system with information about an area. The vehicle 200 may be an autonomous vehicle or a non-autonomous vehicle. Additionally, a vehicle 200 that is providing information about a geographic location may be parked or traveling through the geographic location. Furthermore, not every vehicle 200 is equipped with the same set of sensor resources, nor may be configured with the same set of systems for collecting and/or determining information about an environment. FIG. 2 only provides one example configuration of sensor resources and systems equipped within a vehicle 200. Furthermore, although FIG. 2 references vehicle 200, any vehicle, for example vehicles 120-126, depicted in FIG. 1 and described herein may include the same or a similar configuration as vehicle 200 described with respect to FIG. 2.

In particular, FIG. 2 provides an example schematic of a vehicle 200 including a variety of sensor resources which may be utilized by the vehicle 200 to determine information about an environment and share that information with a computing device implementing the method for predicting ride sharing demand and configuring pricing and/or managing the number of ride sharing vehicles in response to the predicted demand. For example, a vehicle 200 may include a computing device 130 comprising a processor 132 and a non-transitory computer readable memory 134, a proximity sensor 140, a microphone 142, one or more cameras 144, an infrared light emitter 146 and infrared detector 148, a global positioning system (GPS) 150, weather sensors 152, a vehicle speed sensor 154, a LIDAR system 156, and network interface hardware 170. These and other components of the vehicle may be communicatively connected to each other via a communication path 160.

The communication path 160 may be formed from any medium that is capable of transmitting a signal such as, for example, conductive wires, conductive traces, optical waveguides, or the like. The communication path 160 may also refer to the expanse in which electromagnetic radiation and their corresponding electromagnetic waves traverses. Moreover, the communication path 160 may be formed from a combination of mediums capable of transmitting signals. In one embodiment, the communication path 160 comprises a combination of conductive traces, conductive wires, connectors, and buses that cooperate to permit the transmission of electrical data signals to components such as processors, memories, sensors, input devices, output devices, and communication devices. Accordingly, the communication path 160 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 130 may be any device or combination of components comprising a processor 132 and non-transitory computer readable memory 134. The processor 132 may be any device capable of executing the machine-readable instruction set stored in the non-transitory computer readable memory 134. Accordingly, the processor 132 may be an electric controller, an integrated circuit, a microchip, a computer, or any other computing device. The processor 132 is communicatively coupled to the other components of the vehicle 200 by the communication path 160. Accordingly, the communication path 160 may communicatively couple any number of processors 132 with one another, and allow the components coupled to the communication path 160 to operate in a distributed computing environment. Specifically, each of the components may operate as a node that may send and/or receive data. While the embodiment depicted in FIG. 2 includes a single processor 132, other embodiments may include more than one processor 132.

The non-transitory computer readable memory 134 may comprise RAM, ROM, flash memories, hard drives, or any non-transitory memory device capable of storing machine-readable instructions such that the machine-readable instructions can be accessed and executed by the processor 132. The machine-readable instruction set may comprise logic or algorithm(s) written in any programming language of any generation (e.g.. 1GL, 2GL, 3GL, 4GL or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory 134. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 includes a single non-transitory computer readable memory 134, other embodiments may include more than one memory module.

Still referring to FIG. 2, the proximity sensor 140 may be any device or combination of components capable of outputting a signal indicative of the presence or absence of an object within or near the vehicle 200. The proximity sensors 140 may also be a sensor capable of determining a range or distance to an object, for example the distance from the vehicle 200 and another vehicle that is traveling in front of the vehicle 200. The proximity sensor 140 may include one or more sensors including, but not limited to, a camera, a laser distance sensor, an ultrasonic sensor, a radar sensor system, a motion sensor, a heat sensor, to determine the presence or absence of an object alongside, behind, or in front of the vehicle 200. In some embodiments, one or more proximity sensors 140 may be configured to enable an around view monitoring system for the vehicle 200. That is, in embodiments of the present system, the proximity sensor 140 may provide the system with information as to how congested a street is or the number of vehicles that are within an area, (e.g., adjacent the vehicle 200).

The microphone 142 is coupled to the communication path 160 and communicatively coupled to the computing device 130. The microphone 142 may be any device capable of transforming a mechanical vibration associated with sound into an electrical signal indicative of the sound. The microphone 142 may be used to monitor sound levels for purposes such as determining the existence of traffic noise in the environment of the vehicle 200.

The vehicle 200 may further include one or more cameras 144. The one or more cameras 144 may enable a variety of different monitoring, detection, control, and/or warning systems within a vehicle 200. The one or more cameras 144 may be any device having an array of sensing devices (e.g., a CCD array or active pixel sensors) capable of detecting radiation in an ultraviolet wavelength band, a visible light wavelength band, or an infrared wavelength band. The one or more cameras 144 may have any resolution. The one or more cameras 144 may be an omni-direction camera or a panoramic camera. In some embodiments, one or more optical components, such as a mirror, fish-eye lens, or any other type of lens may be optically coupled to the one or more cameras 144. The one or more cameras 144 may be configured to provide a variety of information to the system about an environment. For example, image data captured by the one or more cameras 144 may provide information regarding vehicle traffic, the presence of an accident or construction, the number and/or density of pedestrians in the area, or the like.

In some embodiments, an infrared light emitter 146 and/or infrared detector 148 are coupled to the communication path 160 and communicatively coupled to the computing device 130. Infrared light, also known as infrared radiation is a type of electromagnetic (EM) radiation like visible light, but infrared light is generally invisible to the human eye. EM radiation is transmitted in waves or particles across a range of wavelengths and frequencies. Infrared light waves are longer than those of visible light, just beyond the red end of the visible spectrum. An infrared light emitter 146 emits infrared light in the range of the (EM) spectrum between microwaves and visible light. Infrared light has frequencies from about 300 GHz up to about 400 THz and wavelengths of about 1 millimeter to 740 nanometers, although these values are not absolute. The spectrum of infrared light can be described in sub-divisions based on wavelength and frequency. For example, near-infrared may have a frequency of about 214 THz to about 400 THz and a wavelength to about 1400 nanometers of about 740 nanometers and far-infrared may have a frequency of about 300 GHz to about 2.0 THz and a wavelength of about 1 millimeter to about 15 micrometers. Infrared light may be subdivided into further divisions.

Similarly, an infrared detector 148 may be configured to detect light emitted and/or reflected that is within the infrared light spectrum. The infrared light emitter 146 and infrared detector 148 may be implemented within a vehicle to provide computer vision and navigation capability to the vehicle 200 during low light or poor weather conditions. The infrared detector 148 may be a device configured to capture the presence of infrared light, for example, determining the presence of a reflection of infrared light off an object or may include a CCD array or active pixel sensors that may be configured to generate an image of an environment that is illuminated by or producing infrared light. An infrared light emitter 146 and infrared detector 148 may be implemented in a vehicle 200 to provide navigation support, collision detection, or the like.

Still referring to FIG. 2, a global positioning system, GPS 150, may be coupled to the communication path 160 and communicatively coupled to the computing device 130 of the vehicle 200. The GPS 150 is capable of generating location information indicative of a location of the vehicle 200 by receiving one or more GPS signals from one or more GPS satellites. The GPS signal communicated to the computing device 130 via the communication path 160 may include location information comprising a National Marine Electronics Association (NMEA) message, latitude and longitude data set, a street address, a name of a known location based on a location database, or the like. Additionally, the GPS 150 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas.

Some vehicles 200 may also include weather sensors 152, such as temperature sensors, precipitation gauges, wind meters, UV light sensors, or the like. The weather sensors 152 may be coupled to the communication path 160 and communicatively coupled to the computing device 130. The weather sensors 152 may be any device capable of outputting a signal indicative of a condition such as a temperature level, the presence or an amount of precipitation, the direction and/or speed of the wind, the presence and/or intensity of sunlight or the like. Information collected by the weather sensors 152 may provide the vehicle 200 and/or the system with information that defines the present weather conditions. In response, the system for predicting ride sharing demand and configuring pricing and/or managing the number of ride sharing vehicles in response to the predicted demand may update the prediction for current or future demand. For example, if a pressure sensor indicates that the pressure in the area is dropping this may indicate rain may be imminent and thus people, for example, on the streets walking may start requesting rides. By way of another example, as the temperature increases and/or the amount of sunlight on a summer day increases, people may be more prone to requesting rides than walking to their destination. As such, demand for ride sharing may be predicted to increase.

The vehicle 200 may also include a vehicle speed sensor 154 coupled to the communication path 160 and communicatively coupled to the computing device 130. The vehicle speed sensor 154 may be any sensor or system of sensors for generating a signal indicative of vehicle speed. For example, without limitation, a vehicle speed sensor 154 may be a tachometer that is capable of generating a signal indicative of a rotation speed of a shaft of the engine or a drive shaft. Signals generated by the vehicle speed sensor 154 may be communicated to the computing device 130 and converted a vehicle speed value. The vehicle speed value is indicative of the speed of the vehicle 200. In some embodiments, the vehicle speed sensor 154 comprises an opto-isolator slotted disk sensor, a Hall Effect sensor, a Doppler radar, or the like. In some embodiments, a vehicle speed sensor 154 may comprise data from a GPS 150 for determining the speed of a vehicle 200. The vehicle speed sensor 154 may be provided so that the computing device 130 may determine when the vehicle 200 accelerates, maintains a constant speed, slows down or is comes to a stop. For example, a vehicle speed sensor 154 may provide signals to the computing device 130 indicative of a vehicle 200 slowing down due to a change in traffic conditions.

In some embodiments, the vehicle 200 may include a LIDAR system 156. The LIDAR system 156 is communicatively coupled to the communication path 160 and the computing device 130. A LIDAR system 156 or light detection and ranging is a system and method of using pulsed laser light to measure distances from the LIDAR system 156 to objects that reflect the pulsed laser light. A LIDAR system 156 may be made as solid-state devices with few or no moving parts, including those configured as optical phased-array devices where its prism-like operation permits a wide field-of-view without the weight and size complexities associated with a traditional rotating LIDAR system 156. The LIDAR system 156 is particularly suited to measuring time-of-flight, which in turn can be correlated to distance measurements with objects that are within a field-of-view of the LIDAR system 156. By calculating the difference in return time of the various wavelengths of the pulsed laser light emitted by the LIDAR system 156, a digital 3-D representation of a target or environment may be generated. The pulsed laser light emitted by the LIDAR system 156 include emissions operated in or near the infrared range of the electromagnetic spectrum, for example, having emitted radiation of about 905 nanometers. Sensors such as LIDAR systems 156 can be used by vehicles 200 to provide detailed 3D spatial information for the identification of objects near a vehicle 200, as well as the use of such information in the service of systems for vehicular mapping, navigation and autonomous operations, especially when used in conjunction with geo-referencing devices such as GPS 150 or a gyroscope-based inertial navigation unit (INU, not shown) or related dead-reckoning system, as well as non-transitory computer readable memory 134 (either its own or memory of the computing device 130). Information collected by the LIDAR system 156 may also provide a representation of an environment that may be used to determine pedestrian traffic and/or the density of pedestrians within an area.

Still referring to FIG. 2, vehicles 200 are now more commonly equipped with vehicle-to-vehicle communication systems. Some of the systems rely on network interface hardware 170. The network interface hardware 170 may be coupled to the communication path 160 and communicatively coupled to the computing device 130. The network interface hardware 170 may be any device capable of transmitting and/or receiving data with a network 180 or directly with another vehicle (e.g., vehicle 120-126) equipped with a vehicle-to-vehicle communication system. Accordingly, network interface hardware 170 can include a communication transceiver for sending and/or receiving any wired or wireless communication. For example, the network interface hardware 170 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 170 includes hardware configured to operate in accordance with the Bluetooth wireless communication protocol. In another embodiment, network interface hardware 170 may include a Bluetooth send/receive module for sending and receiving Bluetooth communications to/from a network 180 and/or another vehicle.

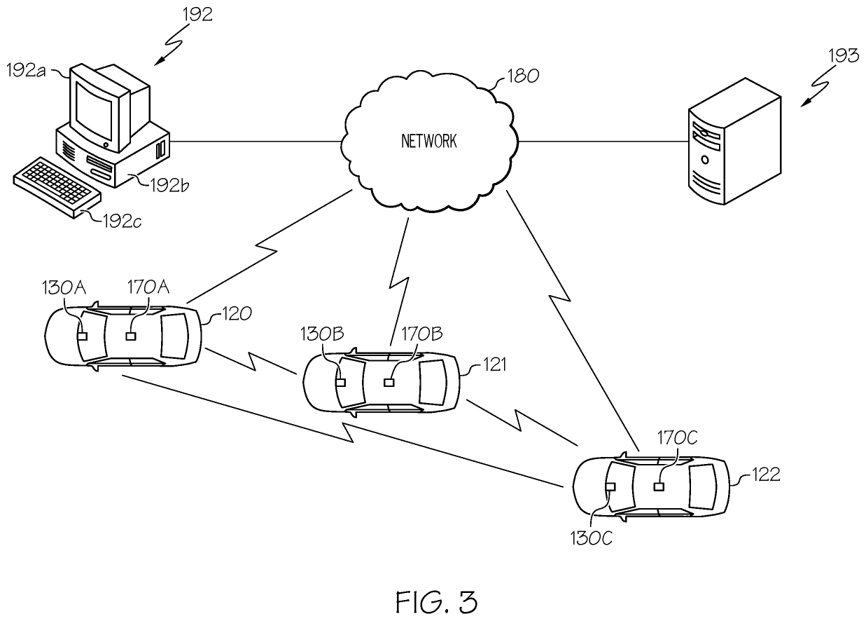

Referring now to FIG. 3, an illustrative embodiment of an automotive edge computing system is depicted. An automotive edge computing system may include vehicle-to-vehicle communication, distributed computing of sensor resources, and/or the sharing of information among vehicles communicatively coupled to the automotive edge computing system. In some embodiments, communication between vehicles 120, 121 and 122 may be direct. That is, a first vehicle 120 may communicate directly with a second vehicle 121 and/or a third vehicle 122, the second vehicle 121 may communicate directly with the first vehicle 120 and/or the third vehicle 122, and the third vehicle 122 may communicate directly with the first vehicle 120 and/or the second vehicle 121. In some embodiments, the vehicles 120, 121 and 122. may communicate with each other through a network 180. In some embodiments, the vehicles 120, 121 and 122 may communicate with one or more remote computing devices 192 and/or servers 193. In addition to communication among the vehicle comprising an automotive edge computing system, one or more vehicles may share in the processing of information collected by sensor resources deployed in vehicles within a geographic location and/or the prediction of ride sharing demand, determination of pricing and/or the management of the number of ride sharing vehicles in response to the predicted demand within a geographic location.

The network 180 may include one or more computer networks (e.g., a personal area network, a local area network, or a wide area network), cellular networks, satellite networks and/or a global positioning system and combinations thereof. Accordingly, the vehicles 120, 121 and 122 and the one or more remote computing devices 192 and/or servers 193 may be communicatively coupled to each other through the network 180 via wires or wireless technologies, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

In particular, FIG. 3 depicts a first vehicle 120 having a computing device 130A, a set of sensor resources (e.g., as shown and described with respect to FIG. 2), and network interface hardware 170A, a second vehicle 121 having a computing device 130B, a set of sensor resources (e.g., as shown and described with respect to FIG. 2), and network interface hardware 170B, and a third vehicle having a computing device 130C, a set of sensor resources (e.g,, as shown and described with respect to FIG. 2), and network interface hardware 170C. As described in more detail herein, each of the vehicles, for example, the first vehicle 120, the second vehicle 121, and the third vehicle 122 may collect information about a geographic location in which they are located, predict demand for the ride sharing in the geographic location based on information about the environment from sensor resources of the vehicle and/or other vehicles, determine a price for ride sharing and/or manage the number of vehicles within the geographic location for ride sharing. Through the combination of information collected relating to an environment and processed by one or more computing devices within a geographic location, demand for ride sharing may be predicted as described in more detail herein. In addition to predicting ride sharing demand based on information collected about an environment, the system and method for predicting ride sharing demand may also be based on a schedule of events for one or more geographic locations.

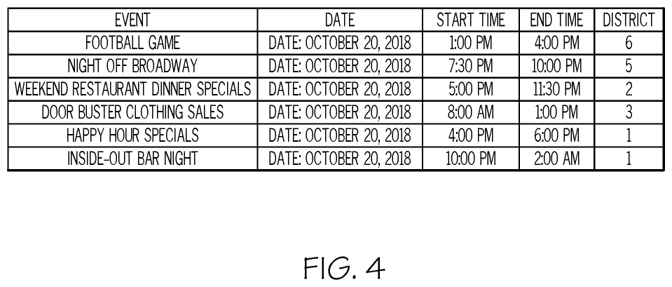

Referring now to FIG. 4, an illustrative schedule of events associated with particular geographic locations (e.g., the districts referred to in FIG. 1) is shown. A schedule of events may provide the system for predicting tide sharing demand with activities and/or events that are planned within particular geographic locations of a city, for example. Based on the schedule of events, the system may correlate real-time information about an environment, for example, as collected by sensor resources from one or more vehicles and the schedule of events to predict which geographic locations in an area may see an influx or exodus of people at particular times that may request ride shares. For example, a football game scheduled for 1:00 PM may indicate an influx of people to district 6 at or around that time followed by an exodus at or around 4:00 PM when the game is estimated to end. Similarly, the theater district, district 5 in the map illustrated in FIG. 1, may have a show starting at 7:30 PM and ending at about 10:00 PM, which may indicate an increase demand for ride shares around those times. Additionally, the restaurant district, which is associated with the city blocks indicated as district 2, may include a number of restaurants in the area that are partaking in a weekend dinner special from 5:00 PM to 11:30 PM. As such, there may be an increase in traffic to and from district 2 before, during, and just after the advertised weekend dinner special times. Similarly, the shopping district may have one or more stores that advertised a clothing sale during the morning and early afternoon hours, which potentially indicates that there will be an increase in ride share demand for that geographic location during those hours.

In some instances, the schedule of events may be used to predict a flow of people from one geographic location to another. For example, district 1, which may be associated with or known for having bars, clubs, lounges or the like may be hosting happy hour specials in the late afternoon and early evening (e.g., from 4:00 PM to 6:00 PM). which may lead to increasing demand during this time. In may be predicted that people at the happy hour event in district 1 may migrate to district 2 (e.g., the restaurant district) for the weekend dinner specials. As such, the system for predicting ride sharing demand may predict increased traffic between these two geographic locations and an increase in ride sharing demand. Similarly, an increased amount of traffic may arise between district 1 and district 2 as the weekend dinner specials at the restaurants wind up for the night and late night events back in district 2 starts at 10:00 PM.

While in some instances, knowing a schedule of events across geographic locations, for example, within a city or town, may be sufficient to predict ride share demand, real-time factors may also contribute to increases and decreases in ride sharing demand. For example, when the weather changes people may seek ride shares in lieu of walking. That is, by receiving real-time information from sensor resources from one or more vehicles about the weather across the geographic locations the system may further refine predictions about ride share demand and provide additional ride share vehicles to the geographic location and/or adjust pricing for ride shares, for example, in an effort to remain relevant and competitive in the ride share real-time marketplace.

The following section will now describe in more detail the method for predicting ride sharing demand and configuring pricing and/or managing the number of tide sharing vehicles in response to the predicted demand utilizing automotive edge computing.

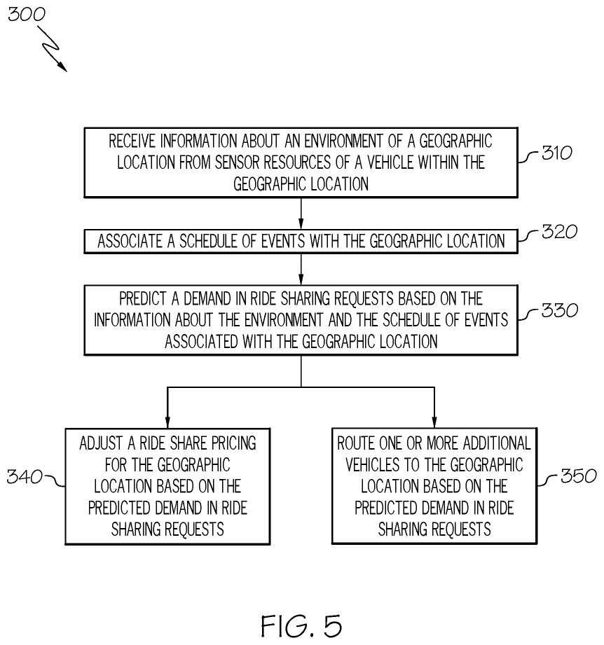

Referring now to FIG. 5, a flowchart 300 of an example method for predicting ride sharing demand and configuring pricing and resources such as the number of ride sharing vehicles in a geographic location in response to the predicted demand is depicted. The method 300 may be carried out by a computing device of a vehicle in the geographic location, a remote computing device, or a combination of both, The flowchart depicted in FIG. 5 is a representation of a machine-readable instruction set stored in the non-transitory computer readable memory 134 and executed by the processor 132 of a computing device 130 or a remote computing device 192. The process of the flowchart 300 in FIG. 5 may be executed at various times and in response to signals from the sensors communicatively coupled to the computing device 130.

In particular, at block 310 the computing device receives information about the environment of a geographic location from sensor resources of a vehicle within the geographic location. The information about an environment collected by vehicles within a geographic location may include real-time or near-real-time information relating to weather conditions, vehicle traffic, population densities, the presence of accidents and/or construction, and the like. Any vehicle equipped with sensor resources and communication capabilities may collect information about an environment. For example, the vehicle collecting information may be a ride sharing vehicle or may be a personal vehicle, a truck, a bus or the like within the geographic location. The information collected about a geographic location may be transmitted to a local computing device. The computing device may be within a vehicle or may be a computing device communicatively coupled to one or more vehicles within the geographic location. The information collected by a vehicle may be associated with a geographic location based on GPS data and a time stamp to track the currentness of the information about the environment in a geographic location.

Information about the geographic location may also be associated with a schedule of events, at block 320. The schedule of events may be stored on a remote computing device and/or server that is accessible by the computing device implementing the method described herein. In some embodiments, the schedule of events may include details (e.g., the date, time, location, attendance estimates, or the like) of events such as a sale at a store, a show time, a game time, a parade start time, a route or road closure that may affect future traffic patterns, event parking locations where people may park for events in the town, and/or the like. Each of these events may indicate locations and times that may correspond to an increase in requests for ride shares. For example, ride share requests may increase at an event parking location prior to the start of a parade or game as people may be seeking a shuttle type ride from the parking locations to the parade or game. The schedule of events may further link events together such as a location for a tailgate and the location of a game, or the location of dining specials at restaurants and the location of a theater production later in the evening. The schedule of events may further include dates, start and end times, and/or other relevant information that may be utilized for predicting demand. For example, a schedule of events that includes an event such as a football game may further include estimated attendance data. The schedule of events may also include historical data relating to typical arrival and/or departure times or people from the event. For example, the schedule of events may provide historical data indicating that 50% of the people attending a football game scheduled to start at 1:00 PM arrive about 30 minutes before game time. Such information from the schedule of events may provide the system with additional data to generate a prediction of ride share demand in and/or across one or more geographic locations, As described above, a geographic location may be a particular address, for example, a baseball stadium, or may be defined as a district such as a restaurant, shopping, or entertainment district that is characterized by the general type of venues or stores in that location.

At block 330, the computing device implementing the method may predict a demand in ride sharing requests based on the information about the environment and the schedule of events associated with the geographic location. In some embodiments, there may not be any events scheduled, but information about the environment indicates a large density of people in the restaurant district based on image data capturing pedestrians on sidewalks in the restaurant district. Additionally, weather sensors from at least one vehicle indicates a drop in barometric pressure, increased cloud coverage (e.g., reduced sun art , and/or the presence of rain. As such, the computing device may predict an approaching increase in ride share demand. It should be understood that this is only one example of conditions utilized to predict ride share demand.

In another example, the schedule of events indicates a football game will be ending soon and that the restaurant district is currently hosting dinner specials. Furthermore, a vehicle may determine that traffic around the restaurant district is dense and moving slowly, therefore, ride share vehicles within the restaurant district may take additional time to relocate to attend to the demand resulting from the end of the football game. As such, the computing device may predict an increase demand for ride shares at the end of the football game in that geographic location.

When a ride share demand is predicted to increase, the computing device may adjust a ride share pricing (e.g., the price per ride is increased) for the geographic location based on the predicted demand in ride sharing requests, at block 340. For example, referring to the above football game example, because an increase in demand is predicted since there may not be sufficient vehicles available due to concurring events and traffic congestion, the computing device may increase the ride share pricing for the requests coming from the geographic location of the football game. As a result, this may reduce the number of actual requests for ride share and/or may encourage ride share vehicles to migrate from the restaurant district to the football game prior to the football game ending. In other embodiments, if ride share demand is predicted to decrease, the computing device may adjust the ride share pricing such that it is decreased.

In some embodiments, at block 350, the computing device may route one or more additional vehicles to a geographic location based on the predicted demand (e.g., an increased demand) in future ride sharing requests. For example, in embodiments where autonomous ride share vehicles are included in the fleet of ride sharing vehicles, the system may route one or more autonomous ride share vehicles to the geographic location where ride share demand is predicted to increase. In embodiments where the ride share vehicles are controlled by a human driver, the driver may be enticed to relocate to service the geographic location where the ride share demand is predicted to increase. That is, the driver may be offered a monetary incentive to service a new location prior to the actual increase in demand so that on-demand service may be maintained.

Conversely, in embodiments where demand is predicted to decrease, the computing device may route one or more vehicles out of the area. For example, one or more autonomous ride share vehicles may be directed back to an “out-of-service” location or may be parked and taken out of service. However, an out-of-service ride share vehicle may still collect information about an environment and provide it to the system to support future ride share demand predictions.

In some embodiments, the computing system may both adjust the ride share price and route one or more additional vehicles to the geographic location where demand is predicted to increase.

It should now be understood that embodiments described herein are directed to systems and methods for predicting ride sharing demand and configuring pricing and/or managing the number of ride sharing vehicles in response to the predicted demand utilizing automotive edge computing. The systems and methods described herein may utilize a computing device and sensor resources of one or more vehicles in a geographic location to collect, process, and share information about an environment. The systems and methods may utilize information about the environment for a geographic location and a schedule of events associated with the geographic location to predict a demand in ride sharing requests. The prediction may be a future estimation of ride share requests that is based on current conditions, known future events, and potential future changes in the environment such as a change in the weather or traffic in the geographic location or an adjacent location. In response to the prediction, the system and method may adjust ride share pricing or actively manage resources such as the number of ride share vehicles that are available in or near the geographic location where the demand is predicted. It is understood that demand may be predicted to increase, decrease, or remain unchanged and the system may adjust the pricing and resources accordingly.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
a processor; and
a non-transitory computer readable memory configured to store a machine-readable instruction set that causes the system to perform at least the following when executed by the processor:
receive, from a sensor resource of a vehicle, information about an environment at a geographic location of the vehicle;
associate a schedule of events with the geographic location;
predict a demand in ride sharing requests based on the information about the environment and the schedule of events associated with the geographic location; and
route one or more additional vehicles to or from the geographic location based on the predicted demand in ride sharing requests.

2. The system of claim 1, wherein the machine-readable instruction set, when executed, further causes the system to:
adjust a ride share pricing for the geographic location based on the predicted demand in ride sharing requests.

3. The system of claim 1, wherein the one or more additional vehicles includes an autonomous vehicle.

4. The system of claim 1, wherein the information about the environment at the geographic location of the vehicle includes a real-time or near-real-time weather information based on a weather sensor of the vehicle.

5. The system of claim 1, wherein the information about the environment at the geographic location is from the sensor resource of a non-ride share vehicle.

6. The system of claim 1, wherein the information about the environment includes at least one of the following:
a traffic condition,
a weather condition,
an estimated number of people in the environment, and
a traveling speed along a route.

7. The system of claim 1, wherein a future increase in the demand is predicted for the geographic location when the information about the environment indicates a presence of rain and the schedule of events indicates a conclusion of an event in the geographic location.

8. A method comprising:
receiving, from a sensor resource of a vehicle, information about an environment at a geographic location of the vehicle;
associating a schedule of events with the geographic location;
predicting a demand in ride sharing requests based on the information about the environment and the schedule of events associated with the geographic location; and
routing one or more additional vehicles to or from the geographic location based on the predicted demand in ride sharing requests.

9. The method of claim 8, further comprising:
adjusting a ride share pricing for the geographic location based on the predicted demand in tide sharing requests.

10. The method of claim 8, wherein the one or more additional vehicles includes an autonomous vehicle.

11. The method of claim 8, wherein the information about the environment at the geographic location of the vehicle includes real-time or near-real-time weather information based on a weather sensor of the vehicle.

12. The method of claim 8, wherein the information about the environment at the geographic location is from the sensor resource of a non-ride share vehicle.

13. The method of claim 8, wherein the information about the environment includes at least one of the following:
a traffic condition,
a weather condition,
an estimated number of people in the environment, or
a traveling speed along a route.

14. The method of claim 8, wherein a future increase in the demand is predicted for the geographic location when the information about the environment indicates a presence of rain and the schedule of events indicates a conclusion of an event in the geographic location.

15. A system comprising:
a first vehicle having a first sensor resource and a first computing device;
a second computing device comprising a processor and a non-transitory computer readable memory;
a network communicatively coupling the first computing device and the second computing device; and
a machine-readable instruction set stored in the non-transitory computer readable memory of the second computing device that causes the system to perform at least the following when executed by the processor:
receive, from the first sensor resource of the first vehicle information about an environment at a geographic location of the first vehicle;
associate a schedule of events with the geographic location;
predict a demand in ride sharing requests based on the information about the environment and the schedule of events associated with the geographic location; and
route one or more additional vehicles to or from the geographic location based on the predicted demand in ride sharing requests.

16. The system of claim 15, wherein the machine-readable instruction set, when executed, further causes the system to:
adjust a ride share pricing for the geographic location based on the predicted demand in ride sharing requests.

17. The system of claim 15, wherein the one or more additional vehicles includes an autonomous vehicle.

18. The system of claim 15, wherein the information about the environment at the geographic location of the first vehicle includes real-time or near-real-time weather information based on a weather sensor of the first vehicle.

19. The system of claim 15, wherein the information about the environment at the geographic location is from the first sensor resource of the first vehicle and the first vehicle is a non-ride share vehicle.

20. The system of claim 15, wherein a future increase in the demand is predicted for the geographic location when the information about the environment indicates a presence of rain and the schedule of events indicates a conclusion of an event in the geographic location.
